(19) United States
(12) Patent Application Publication
(10) Pub. No.: US 2026/0151898 A1
(43) Pub. Date: Jun. 4, 2026

(54) FINGER MECHANISM, MECHANICAL HAND, AND ROBOT

(71) Applicants: ZHEJIANG QIANGNAO TECHNOLOGY CO., LTD., HANGZHOU (CN); SHENZHEN MENTAL FLOW TECHNOLOGY CO.,LTD., SHENZHEN (CN)

(72) Inventors: BICHENG HAN, HANGZHOU (CN); WENGUANG WANG, HANGZHOU (CN); DISI A, HANGZHOU (CN); ZHAN LU, HANGZHOU (CN); YIQIAN GAO, HANGZHOU (CN); JUNHAN LI, HANGZHOU (CN)

(21) Appl. No.: 19/362,492

(22) Filed: Oct. 20, 2025

(30) Foreign Application Priority Data
Dec. 3, 2024 (CN) 202411754949.0

(51) Int. Cl. B25J 9/10; B25J 15/08

(52) U.S. Cl. CPC B25J 9/1045; B25J 15/08

(57) ABSTRACT

The disclosure provides a finger mechanism, a mechanical hand, and a robot. The finger mechanism includes: a finger base; a driving assembly provided on the finger base; a first phalange rotatably connected with the finger base; a second phalange rotatably connected with the first phalange; a connecting rod member with one end being in transmission connection with the driving assembly and the other end being in transmission connection with the second phalange, for driving the first phalange to rotate relative to the finger base and the second phalange to rotate relative to the first phalange under driving by the driving assembly; and an elastic resetting member provided in the accommodating cavity with one end being connected with the first phalange and the other end being connected with the connecting rod member, for driving the first phalange and the second phalange to reset.

### TECHNICAL FIELD

The disclosure relates to the technical field of mechanical hands, in particular to a finger mechanism, a mechanical hand, and a robot.

### BACKGROUND

Mechanical hands are often used to replace human hands for grasping, manipulating and other operations, and have characteristics of being accurate and flexible. As an important part of a humanoid hand, their finger mechanisms can achieve flexion and extension functions similar to those of human fingers.

In related arts, the mechanical hands generally are with a relatively fixed structure, and their finger actions depend entirely on driving by a driver, which lacks autonomous adaptability and flexibility. When the driver is locked or stops operation, the finger mechanism of the mechanical hand may be locked. In this case, once a large external force acts on the finger, the mechanical finger is easily damaged or even broken because the finger cannot move flexibly to buffer or avoid the external force, which affects normal use of the mechanical hand.

### SUMMARY

A main object of the disclosure is to provide a finger mechanism, a mechanical hand, and a robot, aiming at solving technical problems that existing finger mechanisms are not flexible enough and are easily damaged or even broken by external impact.

In order to achieve the above object, the present disclosure provides a finger mechanism, including:
a finger base;
a driving assembly provided on the finger base;
a first phalange rotatably connected with the finger base, the first phalange being defined with an accommodating cavity;
a second phalange rotatably connected with the first phalange;
a connecting rod member penetrating through the accommodating cavity and with one end being in transmission connection with the driving assembly and the other end being in transmission connection with the second phalange, for driving the first phalange to rotate relative to the finger base and the second phalange to rotate relative to the first phalange under driving by the driving assembly; and
an elastic resetting member provided in the accommodating cavity with one end being connected with the first phalange and the other end being connected with the second phalange, for driving the first phalange and the second phalange to reset.

In some embodiments, the connecting rod member includes a first rod segment and a second rod segment which are connected with each other. A length of the first rod segment is larger than a length of the second rod segment, a preset included angle is formed between the first rod segment and the second rod segment, an end of the first rod segment away from the second rod segment is connected with the finger base through a first rotating shaft, and an end of the second rod segment away from the first rod segment is connected with the second phalange through a second rotating shaft.

In some embodiments, a side of the second rod segment away from the second rotating shaft is provided with a first mounting part, an inner wall of the accommodating cavity is extended inward with a second mounting part, one end of the elastic resetting member is connected with the first mounting part, and the other end of the elastic resetting member is connected with the second mounting part; and/or the elastic resetting member is a tension spring.

In some embodiments, the driving assembly includes:
a driving member provided on the finger base and having an output shaft extending into the finger base;
a worm provided within the finger base and connected with the output shaft; and
a worm wheel meshed with the worm and in transmission connection with an end of the connecting rod member.

The driving member is configured to drive the worm to rotate, and drive the connecting rod member to rotate through the worm wheel, to allow the first phalange to rotate relative to the finger base and the second phalange to rotate relative to the first phalange.

In some embodiments, the end of the first rod segment away from the second rod segment is provided with a partition groove, the first rod segment is provided with a mounting holes on opposite sides of the partition groove, the worm wheel is installed in the partition groove, and the first rotating shaft passes through the worm wheel and both ends of the first rotating shaft are installed in respective mounting holes.

In some embodiments, the first phalange is pin-coupled with the finger base; and/or
the connecting rod member is pin-coupled with the finger base; and/or,
the connecting rod member is pin-coupled with the second phalange; and/or,
the second phalange is pin-coupled with the first phalange.

In some embodiments, a connection between the first phalange and the finger base forms a first connection position, a connection between the connecting rod member and the finger base forms a second connection position, a connection between the connecting rod member and the second phalange forms a third connection position, and a connection between the second phalange and the first phalange forms a fourth connection position. The first connection position, the second connection position, the third connection position, and the fourth connection position are in a quadrilateral layout.

In some embodiments, a limiting groove is provided within the finger base, the limiting groove has a groove opening communicated with outside, the connecting rod member is rotatably connected in the limiting groove through the groove opening, and opposite ends of the limiting groove along a rotating direction of the connecting rod member are respectively defined with a limiting end face for limiting an angular range of rotation of the connecting rod member relative to the finger base.

A mechanical hand is further provided in the disclosure, which includes a palm mechanism and the at least one finger mechanism as described above, and the at least one finger mechanism is connected with the palm mechanism.

A robot is further provided in the disclosure, which includes the mechanical hand described above.

The finger mechanism of the disclosure drives the first phalange to rotate relative to the finger base and the second phalange to rotate relative to the first phalange through the driving assembly, so as to realize bending and stretching actions of the finger, improve flexibility of the finger mechanism and realize more complicated operation actions. Moreover, by providing the elastic resetting member, the disclosure can not only realize a reset function of the first phalange and the second phalange, but also function in buffering when the finger mechanism is impacted by an external force. When the finger mechanism encounters an external force, the elastic resetting member can first undergo elastic deformation to absorb and dissipate a part of energy of the external force, thereby reducing impact of the external force on the first phalange, the second phalange, and the whole finger mechanism, effectively protecting the finger mechanism from damage and reducing a risk of being damaged or even broken of the finger mechanism.

### BRIEF DESCRIPTION OF THE DRAWINGS

FIG. 1 is a schematic structural view of a finger mechanism according to an embodiment of the disclosure;

FIG. 2 is a schematic disassembled view of the finger mechanism in FIG. 1;

FIG. 3 is a schematic sectional view of the finger mechanism in FIG. 1;

FIG. 4 is a schematic structural view of a connecting rod member according to an embodiment of the disclosure;

FIG. 5 is a schematic structural view of a finger base according to an embodiment of the disclosure;

FIG. 6 is a schematic sectional view of a finger base according to an embodiment of the disclosure;

FIG. 7 is a schematic structural view of a mechanical hand according to an embodiment of the disclosure; and

FIG. 8 is a schematic structural view of a robot according to an embodiment of the disclosure.

### Reference Numbers are Illustrated as Follows:

100—Finger Mechanism, 10—Finger Base, 20—Driving Assembly, 30—First Phalange, 31—Accommodating Cavity, 40—Second Phalange, 50—Connecting Rod Member, 60—Elastic Restoring Member, 51—First Rod Segment, 52—Second Rod Segment, 53—First Rotating Shaft, 54—Second Rotating Shaft, 521—First Mounting part, 311—Second Mounting Part, 21—Driving Member, 211—Output Shaft, 22—Worm, 23—Worm Wheel, 511—Partition Groove, 512—Mounting Hole, 11—Limiting Groove, 12—Groove Opening, 13—Limiting End Face, 14—First Mounting Cavity, 15—Second Mounting Cavity, 16—Through Hole, 17—Mounting Groove, 18—Friction Ring, 101—First Connection Position, 102—Second Connection Position, 103—Third Connection Position, 104—Fourth Connection Position, 200—Mechanical hand, 201—Palm Mechanism, 300—Robot.

Realization of the objects, functional characteristics and advantages of the disclosure will be further explained in combination with embodiments and with reference to attached figures.

### DETAILED DESCRIPTION OF THE EMBODIMENTS

In the following, the scheme in the embodiment of the disclosure will be described clearly and completely in connection with the drawings. Obviously, the described embodiment is intended to be only a part of the embodiments of the disclosure, but not all of them. On a basis of the embodiments in this disclosure, all other embodiments obtained by the ordinary skilled in the art without any creative effort are within the protection scope of this disclosure.

It should be noted that all of directional indications (such as up, down, left, right, front, back, etc.) in the embodiments of the disclosure are only used to illustrate relative position relationships and movement conditions among respective components in a certain posture (as shown). If the certain posture changes, the directional indications vary accordingly.

It should also be noted that when an element is referred to be “fixed” or “provided” on another element, it may be directly on the another element or an intervening element may exist at the same time. When an element is referred to be “connected” to another element, it may be directly connected to the another element or an intervening element may exist at the same time.

In addition, descriptions involving “first”, “second” or the like in this disclosure are only intended for descriptive purposes, and cannot be understood as indicating or implying a relative importance, or implicitly indicating a number of indicated technical features. Therefore, the features defined with “first” and “second” can explicitly or implicitly include at least one of these features. In addition, technical schemes of respective embodiments can be combined with each other, which must be based on enabling of realization by an ordinary skilled in the art. When combination of technical schemes is contradictory or impossible to be realized, it should be considered that such combination of technical schemes does not exist and either is not within the protection scope claimed in this disclosure.

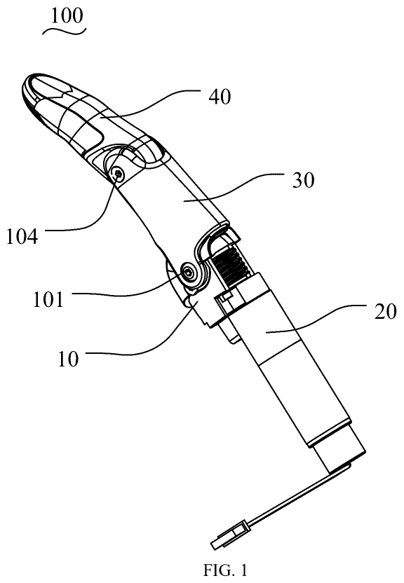

Referring to FIGS. 1 to 3, a finger mechanism 100 is provided in an embodiment of the disclosure, which includes a finger base 10, a driving assembly 20, a first phalange 30, a second phalange 40, a connecting rod member 50, and an elastic resetting member 60. The driving assembly 20 is arranged on the finger base 10. The first phalange 30 is rotatably connected with the finger base 10, and an accommodating cavity 31 is provided in the first phalange 30. The second phalange 40 is rotatably connected with the first phalange 30. The connecting rod member 50 penetrates through the accommodating cavity 31, with one end being in transmission connection with the driving assembly 20 and the other end being in transmission connection with the second phalange 40, for driving the first phalange 30 to rotate relative to the finger base 10 and the second phalange 40 to rotate relative to the first phalange 30 under driving by the driving assembly 20. The elastic resetting member 60 is arranged in the accommodating cavity 31, and one end of the elastic resetting member 60 is connected with the first phalange 30 and the other end of the elastic resetting member is connected with the second phalange 40 for driving the first phalange 30 and the second phalange 40 to reset.

The driving assembly 20 is installed on the finger base 10 as a power source. When the driving assembly 20 starts and outputs power, the power is transmitted through the connecting rod member 50, and the connecting rod member 50 may generate corresponding displacement and force change under an action force of the driving assembly 20. Because the connecting rod member 50 penetrates into the accommodating cavity 31 of the first phalange 30 and the other end of the connecting rod member 50 is in transmission connection with the second phalange 40, this force may cause the first phalange 30 to rotate relative to the finger base 10. Meanwhile, in this process, due to a connection relationship of the connecting rod member 50 and the second phalange 40, the second phalange 40 may also rotate relative to the first phalange 30, thus realizing flexion and extension of the finger.

It should be understood that the driving assembly 20 may be in various forms, such as a small motor, which can convert electric energy into mechanical energy and drive the connecting rod member 50 to act through rotation of the output shaft 211. The driving assembly can also be a pneumatic or hydraulic device, which drives a piston and other components to move by a pressure generated by compressed gas or liquid, and then drives the connecting rod member 50 to realize rotation of the first phalange 30 and the second phalange 40. These different types of driving assemblies 20 can be selected according to specific application scenarios so as to meet requirements of flexible and stable operation of the finger mechanism 100 under various operation conditions.

The elastic resetting member 60 is placed in the accommodating cavity 31 of the first phalange 30 and connected with the first phalange 30 and the second phalange 40. During movement of the finger mechanism 100, when the driving assembly 20 drives the first phalange 30 and the second phalange 40 to rotate, the elastic resetting member 60 may be elastically deformed with relative movement of the phalanges. For example, during bending of the finger, the elastic resetting member 60 may be stretched or compressed, thereby storing elastic potential energy. When the driving assembly 20 stops operation or loses power, the elastic resetting member 60 may utilize its stored elastic potential energy to generate a restoring force which may act on the first phalange 30 and the second phalange 40, to revert them to initial positions and accomplish a rest action. Moreover, when the finger mechanism 100 is subjected to an external impact force or an interference force, the elastic resetting member 60 may first undergo elastic deformation to absorb and dissipate a part of energy of the external force, and reduce impact of the external force on the first phalange 30, the second phalange 40, and the whole finger mechanism 100, so that the finger mechanism 100 can buffer and be adaptively adjusted within a certain range, instead of directly transmitting the impact force like traditional rigid finger mechanisms 100, thereby effectively protecting the finger mechanism 100 from damage and reducing a risk of being damaged or even broken of the finger mechanism 100.

In this embodiment, cooperation between the connecting rod member 50 and the elastic resetting member 60 makes movement of the finger mechanism 100 very flexible. Driven by the driving assembly 20, the finger can realize complex bending and stretching actions, and can be better adapted to objects with different shapes and sizes, improve flexibility of the finger mechanism 100, and realize more complex operations. Moreover, the connecting rod member 50 and the elastic resetting member 60 are arranged in the accommodating cavity 31 of the first phalange 30, which makes full use of its internal space, so that an overall volume of the finger mechanism 100 is not too large, which facilitates layout and installation in equipment such as the mechanical hand 200. Meanwhile, connections between various components are more secure, which reduces motion errors caused by loose components.

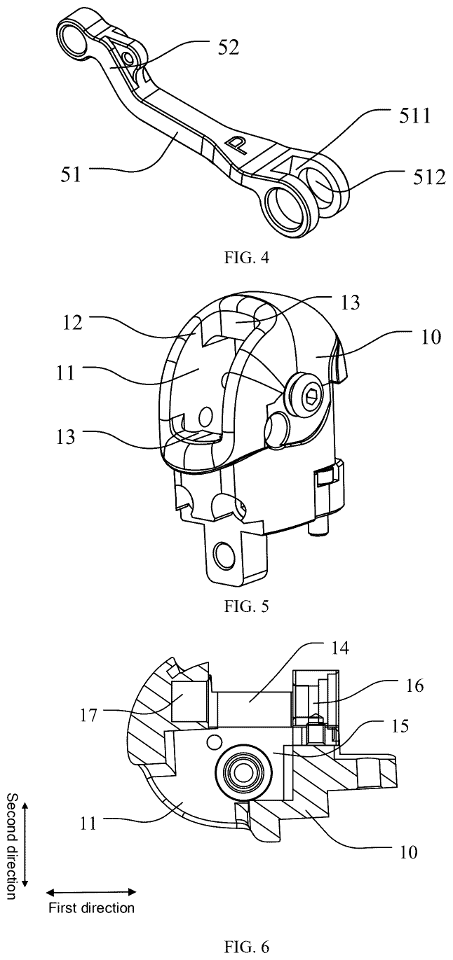

Referring to FIGS. 3 and 4, in some embodiments, the connecting rod member 50 includes a first rod segment 51 and a second rod segment 52 which are connected with each other. A length of the first rod segment 51 is larger than a length of the second rod segment 52, and a preset included angle is formed between the first rod segment 51 and the second rod segment 52, an end of the first rod segment 51 away from the second rod segment 52 is connected with the finger base 10 through a first rotating shaft 53, and an end of the second rod segment 52 away from the first rod segment 51 is connected with the second phalange 40 through a second rotating shaft 54.

In this embodiment, the connecting rod member 50 is composed of the first rod segment 51 and the second rod segment 52 which are connected with each other, and a preset included angle is formed between the first rod segment 51 and the second rod segment 52. This design with the included angle enables the transmission of power at a specific angular relationship during a drive process, altering a direction and magnitude of the force, thereby better accommodating complex motion requirements of the finger mechanism 100. Moreover, the length of the first rod segment 51 is larger than the length of the second rod segment 52, allowing for the amplification or reduction of force and effective angular adjustment during power transmission. According to a lever principle, when the driving assembly 20 acts on the longer end of the first rod segment 51, a larger torque can be obtained at the shorter end of the second rod segment 52, thereby enhancing a gripping force of the finger mechanism 100.

The end of the first rod segment 51 away from the second rod segment 52 is connected with the finger base 10 through the first rotating shaft 53, allowing the first rod segment 51 to rotate freely relative to the finger base 10. Meanwhile, the end of the second rod segment 52 away from the first rod segment 51 is connected with the second phalange 40 through the second rotating shaft 54, so that under action of the driving assembly 20, the connecting rod member 50 can be connected with different components through the first rotating shaft 53 and the second rotating shaft 54 to drive the first phalanges 30 to rotate relative to the finger base 10 and the second phalanges 40 to rotate relative to the first phalanges 30, so that the whole finger mechanism 100 can flexibly bend and extend like a human hand.

In this embodiment, by reasonably setting the lengths of the first rod segment 51 and the second rod segment 52 and the preset included angle, a motion angle range of the finger mechanism 100 can be accurately adjusted. Different combinations of length ratios and included angles can make the finger mechanism 100 adapt to different operation scenes and operation requirements, such as grabbing objects with different sizes and shapes.

In some embodiments, a side of the second rod segment 52 away from the second rotating shaft 54 is provided with a first mounting part 521, and an inner wall of the accommodating cavity 31 is extended inward with a second mounting part 311, one end of the elastic resetting member 60 is connected with the first mounting part 521, and the other end of the elastic resetting member is connected with the second mounting part 311; and/or
the elastic resetting member 60 is a tension spring.

In this embodiment, since the first mounting part 521 is arranged on the second rod segment 52 and the second mounting part 311 is arranged on the inner wall of the accommodating cavity 31, positions of the two mounting parts are relatively fixed and structure is stable, so that the elastic resetting member 60 can stably transmit a restoring force. When the elastic resetting member 60 generates the restoring force, it can directly and effectively act on these two components, ensuring that the first phalange 30 and the second phalange 40 can return to their positions accurately, minimizing incomplete reset or positional deviation caused by an unstable transmission of the reset force.

In this embodiment, when the finger mechanism 100 moves under action of the driving assembly 20, the tension spring has two ends with one connected with the first mounting part 521 of the second rod segment 52 and the other connected with the second mounting part 311 at the inner wall of the accommodating cavity 31. Due to characteristics of the tension spring, it may deform with change of the position of the second rod segment 52 relative to the inner wall of the accommodating cavity 31. For example, when the finger mechanism 100 performs a bending action, the second rod segment 52 moves in a direction close to the inner wall of the accommodating cavity 31, and the tension spring is stretched, at which time the tension spring store elastic potential energy. When the driving assembly 20 stops operation or loses power, the tension spring may try to return to its original length. At this time, the tension spring use the stored elastic potential energy to generate a pulling force, which can act on the second rod segment 52 and the inner wall of the accommodating cavity 31. Due to interaction of forces, the tension spring may pull the second rod segment 52 to move away from the inner wall of the accommodating cavity 31, so as to drive the first phalange 30 and the second phalange 40 to reset through the connection between the connecting rod member 50 and the phalanges.

Compared with other complicated elastic resetting devices, a manufacturing and installation process of the tension spring is relatively simple and has lower cost. Moreover, the tension spring has high reliability, and can operate stably for a long time under normal use conditions as long as it does not exceed its elastic limit, thus reducing maintenance cost of the finger mechanism 100 caused by failure of the elastic resetting member 60. In addition, the tension spring can maintain its elasticity over a wide range of deformation. This characteristic allows the finger mechanism 100 to effectively utilize the tension spring for resetting across varying degrees of motion. Regardless of whether the finger mechanism 100 performs minor adjustment or large bending action, the tension spring can store and release elastic potential energy according to its deformation, ensuring reliable reset performance of the finger mechanism 100 under various operation conditions.

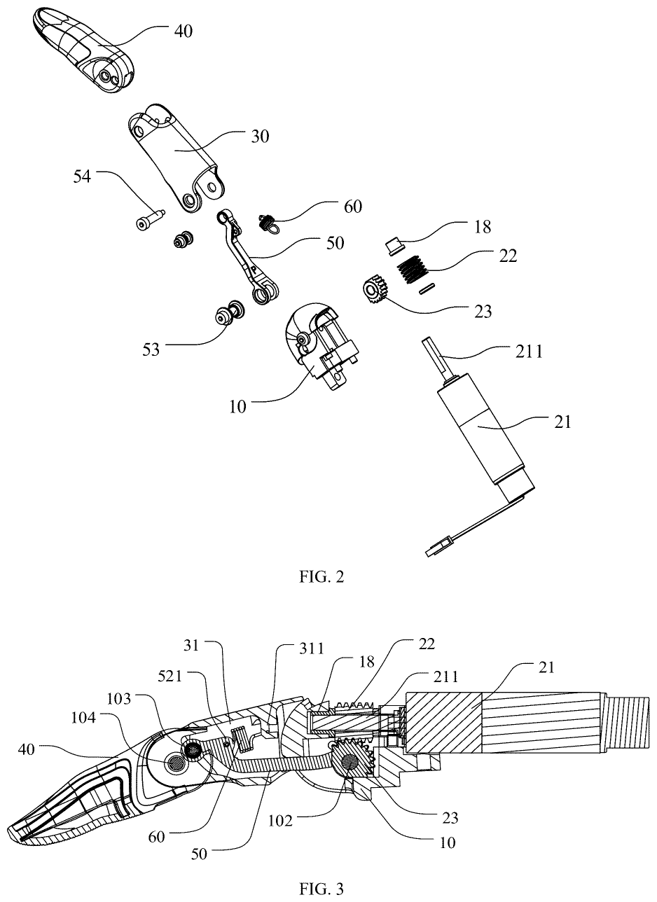

Continue to referring to FIGS. 2 and 3, in some embodiments, the driving assembly 20 includes a driving member 21, a worm 22, and a worm wheel 23. The driving member 21 is arranged on the finger base 10 and has an output shaft 211 extending into the finger base 10. The worm 22 is arranged in the finger base 10 and connected with the output shaft 211. The worm wheel 23 is meshed with the worm 22 and is in transmission connection with an end of the connecting rod member 50.

The driving member 21 is configured to drive the worm 22 to rotate, and drive the connecting rod member 50 to rotate through the worm wheel 23 so as to drive the first phalange 30 to rotate relative to the finger base 10 and the second phalange 40 to rotate relative to the first phalange 30.

As an initial power source of the whole driving assembly 20, the driving member 21 is installed on the finger base 10, and its output shaft 211 extending into the finger base 10 can output power. When the driving member 21 starts to operate (for example, the motor is energized to rotate), the output shaft 211 starts to rotate. Because the worm 22 is connected with the output shaft 211 and the worm wheel 23 is meshed with the worm wheel 22, the worm wheel 22 can rotate synchronously with the output shaft 211, and spiral teeth of the worm wheel 22 may drive the worm wheel 23 to rotate. The worm wheel 23 is in transmission connection with an end of the connecting rod member 50, and thus rotating motion of the worm wheel 23 is transmitted to the connecting rod member 50. As described above, the connecting rod member 50, through its own structure (the first rod segment 51, the second rod segment 52, and connection of the rotating shafts with respective components, etc.), can drive the first phalange 30 to rotate relative to the finger base 10 after receiving power transmitted from the worm wheel 23, and further drive the second phalange 40 to rotate relative to the first phalange 30, so as to finally realize bending and extension of the whole finger mechanism 100 like a human hand, and complete functions such as grasping and manipulating objects.

In this embodiment, the adoption of the worm 22 and the worm wheel 23 transmission mechanism achieves a high transmission ratio. It converts a relatively high rotation speed of the output shaft 211 of the driving member 21 into a lower rotation speed at an end of the worm wheel 23 while simultaneously increasing the torque. Consequently, when the finger mechanism 100 is driven, even if a torque output by the driving member 21 is limited, the transmission through the worm wheel 23 and the worm 22 can supply a sufficient torque to the connecting rod member 50, ensuring that the phalanges can be driven to rotate powerfully, and meeting the force demand of the finger mechanism 100 for operations such as grasping objects, with particularly notable advantages when grasping heavier objects or those requiring greater gripping force.

Further, the driving member 21, the worm 22, and the worm wheel 23 are all arranged in or mounted closely to the finger base 10, this configuration features a relatively compact layout that makes full use of the space inside and around the finger base 10. It prevents the driving assembly 20 from occupying excessive external space, which contributes to the miniaturization and integration of an overall structure of the finger mechanism 100, and facilitates its application in devices such as mechanical hands 200 with varying size requirements. Moreover, the compact structure also makes connection between components more stable and reduces transmission error caused by a loose structure.

In some embodiments, the end of the first rod segment 51 away from the second rod segment 52 is provided with a partition groove 511, the first rod segment 51 is provided with mounting holes 512 on opposite sides of the partition groove 511, the worm wheel 23 is installed in the partition groove 511, and the first rotating shaft 53 passes through the worm wheel 23 and both ends of the first rotating shaft 53 are installed in respective mounting holes 512.

The partition groove 511 provided in the first rod segment 51 provides a mounting space for the worm wheel 23, allowing it to be placed within. This integrates the originally relatively independent driving assembly 20 and connecting rod member 50 more closely in terms of spatial arrangement, reducing the gaps between components and eliminating unnecessary connection structures between components. As such, the overall structure of the whole finger mechanism 100 becomes more compact. This compact structure facilitates integration of more functional components within a limited space, or makes the finger mechanism 100 occupy less space when it is installed on a mechanical hand 200 and other apparatuses, which contributes to the miniaturization and layout optimization of the whole apparatus.

Further, stable connection between the worm wheel 23 and the first rod segment 51 by means of the first rotating shaft 53 ensures stability in a process of power transmission. In some embodiments, two ends of the first rotating shaft 53 are accurately installed in the mounting holes 512, allowing the worm wheel 23 to stably drive the rotation of the first rod segment 51 during operation, which prevents issues such as power transmission interruption or deviation in transmission angle caused by loose connection or insecure installation. As such, the reliability of the whole transmission chain, from the driving assembly 20 to the rotation of the phalange, is ensured, allowing the finger mechanism 100 to operate more smoothly and accurately. This also contributes to improving the performance of the finger mechanism 100 during prolonged use.

In some embodiments, the first phalange 30 is pin-coupled with the finger base 10; and/or,
the connecting rod member 50 is pin-coupled with the finger base 10; and/or,
the connecting rod member 50 is pin-coupled with the second phalange 40; and/or,
the second phalange 40 is pin-coupled with the first phalange 30.

In this embodiment, a pin-coupling method provides flexibility of relative rotation between the respective components. Whether it is the first phalange 30 relative to the finger base 10, the connecting rod member 50 relative to other components, or the second phalange 40 relative to the first phalange 30, each can rotate freely within a certain range around the pin. This flexibility allows the finger mechanism 100 to simulate flexion and extension movements of a human hand more naturally and smoothly, enabling it to better adapt to grasping objects with varying shapes, sizes, and textures. For example, when grasping a spherical object, each phalanges can flexibly rotate to conform to the object's surface, realizing a stable grasp.

In an assembly process of the finger mechanism 100, an operation of pin-coupling is relatively simple. Workers simply need to align corresponding pin holes on respective components and insert the pins to complete the connection. This helps improving production and assembly efficiency while reducing assembly cost. Moreover, during subsequent use, if issues such as wear occur at a pin connection point requiring repair or part replacement, the disassembly and reinstallation can be carried out more easily. This facilitates maintenance of the whole finger mechanism 100 and helps prolonging its service life.

In some embodiments, a connection between the first phalange 30 and the finger base 10 forms a first connection position 101, a connection between the connecting rod member 50 and the finger base 10 forms a second connection position 102, a connection between the connecting rod member 50 and the second phalange 40 forms a third connection position 103, and a connection between the second phalange 40 and the first phalange 30 forms a fourth connection position 104. The first connection position 101, the second connection position 102, the third connection position 103, and the fourth connection position 104 are in a quadrilateral layout.

The quadrilateral layout plays a constraint role on the spatial positions and angles of respective components. Taking the first phalange 30 and the second phalange 40 as an example, due to the presence of the fourth connection position 104 and its position within the quadrangular layout, the range of rotation of the second phalange 40 relative to the first phalange 30 may be limited by this layout. This prevents over-rotation beyond the design expectations, ensuring accuracy and stability of movement of the finger mechanism 100.

Similarly, in the connections between the connecting rod member 50 and the finger base 10 and between the connecting rod member 50 and the second phalange 40, the quadrilateral layout formed by the second connecting position 102 and the third connecting position 103 restricts a swing angle and displacement of the connecting rod 50 within a certain range. This ensures that the motion trajectory of the whole finger mechanism 100 is more predictable and aligned with the design requirements, facilitating precise operations such as grasping objects with different shapes. For example, when grasping a rectangular object, each phalanges can accurately adjust its angle and position within the constrained motion range defined by the quadrilateral layout to conform to the surface of the object.

In this embodiment, the quadrilateral layout constructs a relatively stable structural configuration, ensuring more orderly and stable relative movement between respective connecting positions. During repeated flexion and extension movements of the finger mechanism 100, force transmission and movement coordination among components are conducted within the framework of the layout. This reduces instabilities such as shaking or deviation caused by uncoordinated movement between the components, enabling more reliable execution of tasks such as grasping and manipulating. Especially during prolonged continuous operation, the finger mechanism 100 is still able to maintain stable movement performance, thereby enhancing the overall performance and service life of the finger mechanism 100.

Referring to FIG. 5, a limiting groove 11 is provided within the finger base 10, the limiting groove 11 has a groove opening 12 communicated with outside, and the connecting rod member 50 is rotatably connected in the limiting groove 11 through the groove opening 12. Opposite ends of the limiting groove 11 along a rotating direction of the connecting rod member 50 are respectively defined with a limiting end face 13 for limiting an angular range of rotation of the connecting rod member 50 relative to the finger base 10.

The connecting rod member 50 enters the limiting groove 11 through the groove opening 12 of the finger base 10 and is rotatably connected within it, providing a relatively stable rotational space for the connecting rod member 50 within the finger base 10. When the driving assembly 20 drives the connecting rod member 50 to rotate, the connecting rod member 50 may rotate around a connection point in the limiting groove 11. The limiting end faces 13 at both ends of the limiting groove 11 along the rotation direction of the connecting rod member 50 play a critical restraining role. As the connecting rod member 50 rotates in one direction, it may gradually approach one of the limiting end faces 13. Upon contact with this limiting end face 13, the connecting rod member 50 is prevented from further rotation in that direction due to obstruction of the limiting end face 13, thus limiting its rotation angle in that direction. Similarly, when rotating in the opposite direction, the other limiting end face 13 serves the same restraining function, thus effectively confining the angular range of rotation of the connecting rod member 50 relative to the finger base 10.

Due to the presence of the limiting groove 11 and the limiting end faces 13, the rotation angle of the connecting rod member 50 can be accurately controlled. This, in turn, indirectly controls rotation angles of the first phalange 30 relative to the finger base 10 and the second phalange 40 relative to the first phalange 30, thereby improving movement accuracy of the whole finger mechanism 100. This effectively prevents excessive rotation of the connecting rod member 50 and prevents component damage caused by excessive movement.

Referring to FIGS. 3 and 6, in some embodiments, the output shaft 211 of the driving member 21 is arranged in a first direction, and the worm 22 and the worm wheel 23 are arranged in a second direction, where the second direction is perpendicular to the first direction.

A first mounting cavity 14 and a second mounting cavity 15 which are communicated in the second direction are provided within the finger base 10. The first mounting cavity 14 is configured to mount the output shaft 211 and the worm 22, and the second mounting cavity 15 is configured to mount the worm wheel 23.

The output shaft 211 of the driving member 21 is arranged along the first direction, while the worm 22 and the worm wheel 23 are arranged along the second direction perpendicular to the first direction, so that effective directional change can be realized during power transmission, converting axial movement of the output shaft 211 into rotational movement in a plane where the worm 22 and the worm wheel 23 are located. This allows for efficient space utilization and adapts to transmission relationships among various components. For example, the output shaft 211 outputs power in a horizontal direction (assumed as the first direction), which is then transmitted and converted by the worm 22 and the worm wheel 23 arranged in a perpendicular direction (assumed as the second direction). This avoiding space waste or structural interference caused by excessive elongation of components in a same direction.

Within the finger base 10, the first mounting cavity 14 and the second mounting cavity 15 which are communicated in the second direction are configured to mount the output shaft 211, the worm 22, and the worm wheel 23, to provide accurate and stable mounting positions for the respective components. The first mounting cavity 14 accommodates the output shaft 211 and the worm 22, ensuring that they can be securely connected within a same space and ensuring smooth power transmission from the output shaft 211 to the worm 22. The second mounting cavity 15 accommodates the worm wheel 23, positioning it at a proper meshing location with the worm 22. Within the second mounting cavity 15, the worm wheel 23 can rotate stably and, after receiving power from the worm 22, further transmit the power outward through an interconnected spatial configuration. The whole layout creates an optimal physical environment for transmission of the worm wheel 23 and the worm 22.

When the driving member 21 is activated, its output shaft 211 oriented in the first direction starts to rotate. Because the output shaft 211 is connected with the worm 22 in the first mounting cavity 14, power can be directly transmitted to the worm 22, causing the worm 22 to rotate in the second direction. In this process, the structure of the first mounting cavity 14 limits relative position and ensures connection stability of the output shaft 211 and the worm 22, thereby ensuring reliable power transmission. The worm 22, rotated in the second direction, meshes with the worm wheel 23 located in the second mounting cavity 15. According to a transmission principle of the worm 22 and the worm wheel 23, the worm 22 drives the worm wheel 23 to rotate.

In this embodiment, the communication design of the first mounting cavity 14 and the second mounting cavity 15 ensures that the meshing state between the worm 22 and the worm wheel 23 remains optimal and stable. This prevents transmission issues such as disengagement or jamming due to an unreasonable spatial structure, thereby ensuring continuous and smooth power transfer from the worm 22 to the worm wheel 23. The power is then transmitted through the subsequent connecting rod member 50 to drive the motion of the phalanges, to realize functionality of the finger mechanism 100.

Further, in this embodiment, the output shaft 211 of the driving member 21 is arranged perpendicularly to the worm 22 and the worm wheel 23. This configuration, combined with the interconnected installation mounting cavities in the finger base 10 designed along a corresponding direction, significantly improves the space utilization efficiency in the finger base 10. All components can be compactly and orderly arranged in the limited space, which avoids space waste caused by disorganized layout or elongation of the components in the same direction. This approach contributes to realization of miniaturization and lightweight structure of the mechanical hand 200.

In some embodiments, the finger base 10 is provided with a through hole 16 and a mounting groove 17 along the first direction, both of which are communicated with the first mounting cavity 14. The through hole 16 is space apart from the mounting groove 17, the through hole 16 is configured for the output shaft 211 to penetrate into the first mounting groove 17, and the mounting groove 17 is configured to accommodate a free end of the output shaft 211.

During assembling of the finger mechanism 100, the output shaft 211 can be smoothly inserted into the first mounting cavity 14 inside the finger base 10 through the through hole 16, allowing the output shaft 211 being accurately connected with the worm 22 installed in the first mounting cavity 14. The dimensions and position of the through hole 16 are designed according to specification of the output shaft 211 and connection requirements with the worm 22, so as to ensure that the output shaft 211 can maintain an correct axial alignment during the insertion process. This establishes the foundation for stable power transmission in subsequent operations.

The mounting groove 17, which is arranged opposite to the through hole 16, is configured to accommodate the free end of the output shaft 211. After the output shaft 211 passes through the through hole 16 into the first mounting cavity 14 and connects with the worm 22, the mounting groove 17 securely accommodate the free end of the output shaft 211. On one hand, this prevents the unsupported free end from shaking during operation of the finger mechanism 100, which could otherwise affect the stability of power transmission. On the other hand, by positioning the free end via the mounting groove 17, the position of the output shalt 211 along the first direction is further constrained, this ensures a more precise positional relationship between the whole driving member 21 and the finger base 10, enabling power to be smoothly transmitted from the driving member 21 to the worm 22 as per the design requirements.

In this embodiment, design of the through hole 16 and the mounting groove 17 enables precise installation and positioning of the output shaft 211 of the driving member 21 on the finger base 10. Specifically, the output shaft 211 accurately enters the first mounting cavity 14 through the through hole 16 to be docked with the worm 22, and the free end of the output shaft 211 is properly received by the mounting groove 17. This well-defined installation method avoids positional deviation of the output shaft 211 caused by manual installation error or inaccurate component fitting, thereby improving the overall assembly accuracy of the finger mechanism 100, and creating favorable conditions for subsequent stable power transmission and accurate movement control.

In some embodiments, a friction ring 18 is respectively provided between the worm 22 and the limiting groove 11, and between the worm 22 and the through hole 16.

When the driving member 21 drives the worm 22 to rotate, the friction between the friction ring 18 and the worm 22, the limiting groove 11, or the through hole 16 imparts a certain damping effect on the rotation of the worm 22. This damping helps preventing uncontrolled rotation speed of the worm 22 due to sudden power changes (such as abrupt variations in the rotation speed of the output shaft 211 of the driving member 21). For example, when the driving member 21 suddenly accelerates or decelerates, the friction force from the friction ring 18 can ensure a smoother transition in the worm 22's rotation speed. Thereby, it stabilizes the power transmission from the driving member 21 to the worm 22, and subsequently through the worm wheel 23 and the connecting rod member 50 to the phalanges, resulting in smoother motion of the finger mechanism 100.

The friction ring 18's ability to regulate the rotational speed and position of the worm 22 ensures more stable power transmission throughout the finger mechanism 100, thus movement accuracy of the finger mechanism 100 is further improved. Moreover, by cushioning impacts and friction between the worm 22 and components such as the through hole 16 and the limiting groove 11, the friction ring 18 effectively protects these components and reduces their wear. This avoids component damage or movement instability caused by impact, thus improving the reliability and adaptability of the finger mechanism 100.

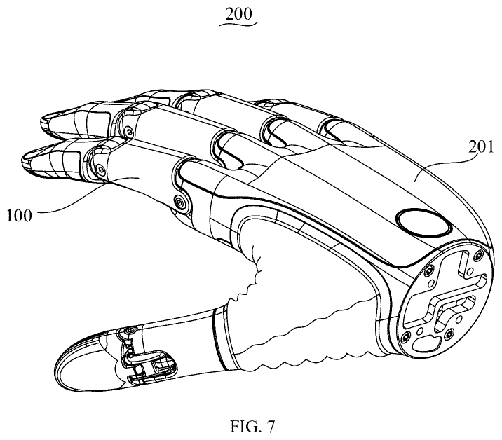

Referring to FIG. 7, a mechanical hand 200 is further provided in the disclosure, which includes a palm mechanism 201 and at least one finger mechanism 100 described above, and the at least one finger mechanism 100 is connected with the palm mechanism 201. Since the mechanical hand 200 adopts all of technical schemes of all of the embodiments of the finger mechanism 100, the mechanical hand 200 of the disclosure also has at least all of beneficial effects brought by the technical schemes of the above embodiments, which will not be repeated here.

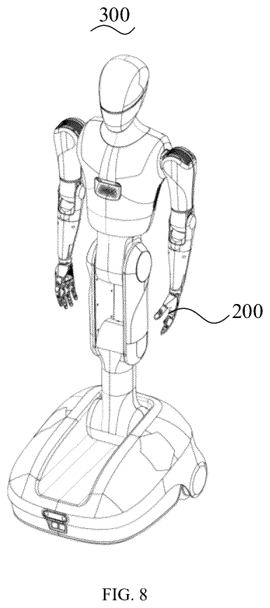

Referring to FIG. 8, a robot 300 is further provided in the disclosure, which includes the mechanical hand 200 described above. Since the robot 300 adopts all of technical schemes of all of the embodiments of the finger mechanism 100, the robot 300 of the disclosure also has at least all of beneficial effects brought by the technical schemes of the above embodiments, which will not be repeated here.

The above embodiments are only examples for clearly explaining the disclosure, but not limitation on implementations of the disclosure. For those ordinary skilled in the art, other variations and modifications can be made based on above description. It is impossible to exhaust all of embodiments herein. All of obvious changes or variations derived from the technical schemes of the disclosure are still within the protection scope of the disclosure.

What is claimed is:

1. A finger mechanism, comprising:
a finger base;
a driving assembly provided on the finger base;
a first phalange rotatably connected with the finger base, the first phalange being defined with an accommodating cavity;
a second phalange rotatably connected with the first phalange;
a connecting rod member penetrating through the accommodating cavity and with one end being in transmission connection with the driving assembly and the other end being in transmission connection with the second phalange, for driving the first phalange to rotate relative to the finger base and the second phalange to rotate relative to the first phalange under driving by the driving assembly; and
an elastic resetting member provided in the accommodating cavity with one end being connected with the first phalange and the other end being connected with the connecting rod member, for driving the first phalange and the second phalange to reset; wherein
the connecting rod member comprises a first rod segment and a second rod segment which are connected with each other, a length of the first rod segment is larger than a length of the second rod segment, and a preset included angle is formed between the first rod segment and the second rod segment, an end of the first rod segment away from the second rod segment is connected with the finger base through a first rotating shaft, and an end of the second rod segment away from the first rod segment is connected with the second phalange through a second rotating shaft;
a side of the second rod segment away from the second rotating shaft is provided with a first mounting part, and an inner wall of the accommodating cavity is extended inward with a second mounting part, one end of the elastic resetting member is connected with the first mounting part, and the other end of the elastic resetting member is connected with the second mounting part; and
the first phalange is of a cylindrical structure, the accommodating cavity is defined in the cylindrical structure, a second mounting cavity is provided in the finger base, one end of the connecting rod member penetrates through the second mounting cavity, and the other end of the connecting rod member penetrates through the accommodating cavity.

2. The finger mechanism according to claim 1, wherein the elastic resetting member is a tension spring.

3. The finger mechanism according to claim 1, wherein the driving assembly comprises:
a driving member provided on the finger base and having an output shaft extending into the finger base;
a worm provided within the finger base and connected with the output shaft; and
a worm wheel meshed with the worm and in transmission connection with an end of the connecting rod member;
wherein the driving member is configured to drive the worm to rotate, and drive the connecting rod member to rotate through the worm wheel, to allow the first phalange to rotate relative to the finger base and the second phalange to rotate relative to the first phalange.

4. The finger mechanism according to claim 3, wherein the end of the first rod segment away from the second rod segment is provided with a partition groove, the first rod segment is provided with mounting holes on opposite sides of the partition groove, the worm wheel is installed in the partition groove, and the first rotating shaft passes through the worm wheel and both ends of the first rotating shaft are installed in respective mounting holes.

5. The finger mechanism according to claim 1, wherein the first phalange is pin-coupled with the finger base; and/or
the connecting rod member is pin-coupled with the finger base; and/or,
the connecting rod member is pin-coupled with the second phalange; and/or,
the second phalange is pin-coupled with the first phalange.

6. The finger mechanism according to claim 5, wherein a connection between the first phalange and the finger base forms a first connection position, a connection between the connecting rod member and the finger base forms a second connection position, a connection between the connecting rod member and the second phalange forms a third connection position, and a connection between the second phalange and the first phalange forms a fourth connection position, and the first connection position, the second connection position, the third connection position, and the fourth connection position are in a quadrilateral layout.

7. The finger mechanism according to claim 5, wherein a limiting groove is provided within the finger base, the limiting groove has a groove opening communicated with outside, the connecting rod member is rotatably connected in the limiting groove through the groove opening, and opposite ends of the limiting groove along a rotating direction of the connecting rod member are respectively defined with a limiting end face for limiting an angular range of rotation of the connecting rod member relative to the finger base.

8. A mechanical hand, comprising a palm mechanism and at least one finger mechanism, the at least one finger mechanism being connected with the palm mechanism;
the at least one finger mechanism comprising:
a finger base;
a driving assembly provided on the finger base;
a first phalange rotatably connected with the finger base, the first phalange being defined with an accommodating cavity;
a second phalange rotatably connected with the first phalange;
a connecting rod member penetrating through the accommodating cavity and with one end being in transmission connection with the driving assembly and the other end being in transmission connection with the second phalange, for driving the first phalange to rotate relative to the finger base and the second phalange to rotate relative to the first phalange under driving by the driving assembly; and
an elastic resetting member provided in the accommodating cavity with one end being connected with the first phalange and the other end being connected with the connecting rod member, for driving the first phalange and the second phalange to reset; wherein
the connecting rod member comprises a first rod segment and a second rod segment which are connected with each other, a length of the first rod segment is larger than a length of the second rod segment, and a preset included angle is formed between the first rod segment and the second rod segment, an end of the first rod segment away from the second rod segment is connected with the finger base through a first rotating shaft, and an end of the second rod segment away from the first rod segment is connected with the second phalange through a second rotating shaft;
a side of the second rod segment away from the second rotating shaft is provided with a first mounting part, and an inner wall of the accommodating cavity is extended inward with a second mounting part, one end of the elastic resetting member is connected with the first mounting part, and the other end of the elastic resetting member is connected with the second mounting part; and
the first phalange is of a cylindrical structure, the accommodating cavity is defined in the cylindrical structure, a second mounting cavity is provided in the finger base, one end of the connecting rod member penetrates through the second mounting cavity, and the other end of the connecting rod member penetrates through the accommodating cavity.

9. The mechanical hand according to claim 8, wherein the driving assembly comprises:
a driving member provided on the finger base and having an output shaft extending into the finger base;
a worm provided within the finger base and connected with the output shaft; and
a worm wheel meshed with the worm and in transmission connection with an end of the connecting rod member;
wherein the driving member is configured to drive the worm to rotate, and drive the connecting rod member to rotate through the worm wheel, to allow the first phalange to rotate relative to the finger base and the second phalange to rotate relative to the first phalange.

10. The mechanical hand according to claim 9, wherein the end of the first rod segment away from the second rod segment is provided with a partition groove, the first rod segment is provided with mounting holes on opposite sides of the partition groove, the worm wheel is installed in the partition groove, and the first rotating shaft passes through the worm wheel and both ends of the first rotating shaft are installed in respective mounting holes.

11. The mechanical hand according to claim 8, wherein the first phalange is pin-coupled with the finger base; and/or
the connecting rod member is pin-coupled with the finger base; and/or,
the connecting rod member is pin-coupled with the second phalange; and/or,
the second phalange is pin-coupled with the first phalange.

12. The mechanical hand according to claim 11, wherein a connection between the first phalange and the finger base forms a first connection position, a connection between the connecting rod member and the finger base forms a second connection position, a connection between the connecting rod member and the second phalange forms a third connection position, and a connection between the second phalange and the first phalange forms a fourth connection position, and the first connection position, the second connection position, the third connection position, and the fourth connection position are in a quadrilateral layout.

13. The mechanical hand according to claim 11, wherein a limiting groove is provided within the finger base, the limiting groove has a groove opening communicated with outside, the connecting rod member is rotatably connected in the limiting groove through the groove opening, and opposite ends of the limiting groove along a rotating direction of the connecting rod member are respectively defined with a limiting end face for limiting an angular range of rotation of the connecting rod member relative to the finger base.

14. A robot, comprising a mechanical hand, the mechanical hand comprising a palm mechanism and at least one finger mechanism, the at least one finger mechanism being connected with the palm mechanism;
the at least one finger mechanism comprising:
a finger base;
a driving assembly provided on the finger base;
a first phalange rotatably connected with the finger base, the first phalange being defined with an accommodating cavity;
a second phalange rotatably connected with the first phalange;
a connecting rod member penetrating through the accommodating cavity and with one end being in transmission connection with the driving assembly and the other end being in transmission connection with the second phalange, for driving the first phalange to rotate relative to the finger base and the second phalange to rotate relative to the first phalange under driving by the driving assembly; and
an elastic resetting member provided in the accommodating cavity with one end being connected with the first phalange and the other end being connected with the connecting rod member, for driving the first phalange and the second phalange to reset; wherein
the connecting rod member comprises a first rod segment and a second rod segment which are connected with each other, a length of the first rod segment is larger than a length of the second rod segment, and a preset included angle is formed between the first rod segment and the second rod segment, an end of the first rod segment away from the second rod segment is connected with the finger base through a first rotating shaft, and an end of the second rod segment away from the first rod segment is connected with the second phalange through a second rotating shaft;
a side of the second rod segment away from the second rotating shaft is provided with a first mounting part, and an inner wall of the accommodating cavity is extended inward with a second mounting part, one end of the elastic resetting member is connected with the first mounting part, and the other end of the elastic resetting member is connected with the second mounting part; and
the first phalange is of a cylindrical structure, the accommodating cavity is defined in the cylindrical structure, a second mounting cavity is provided in the finger base, one end of the connecting rod member penetrates through the second mounting cavity, and the other end of the connecting rod member penetrates through the accommodating cavity.

15. The robot according to claim 14, wherein the driving assembly comprises:
a driving member provided on the finger base and having an output shaft extending into the finger base;
a worm provided within the finger base and connected with the output shaft; and
a worm wheel meshed with the worm and in transmission connection with an end of the connecting rod member;
wherein the driving member is configured to drive the worm to rotate, and drive the connecting rod member to rotate through the worm wheel, to allow the first phalange to rotate relative to the finger base and the second phalange to rotate relative to the first phalange.

16. The robot according to claim 15, wherein the end of the first rod segment away from the second rod segment is provided with a partition groove, the first rod segment is provided with mounting holes on opposite sides of the partition groove, the worm wheel is installed in the partition groove, and the first rotating shaft passes through the worm wheel and both ends of the first rotating shaft are installed in respective mounting holes.

17. The robot according to claim 14, wherein the first phalange is pin-coupled with the finger base; and/or
the connecting rod member is pin-coupled with the finger base; and/or,
the connecting rod member is pin-coupled with the second phalange; and/or,
the second phalange is pin-coupled with the first phalange.

18. The robot according to claim 17, wherein a connection between the first phalange and the finger base forms a first connection position, a connection between the connecting rod member and the finger base forms a second connection position, a connection between the connecting rod member and the second phalange forms a third connection position, and a connection between the second phalange and the first phalange forms a fourth connection position, and the first connection position, the second connection position, the third connection position, and the fourth connection position are in a quadrilateral layout.

19. The robot according to claim 17, wherein a limiting groove is provided within the finger base, the limiting groove has a groove opening communicated with outside, the connecting rod member is rotatably connected in the limiting groove through the groove opening, and opposite ends of the limiting groove along a rotating direction of the connecting rod member are respectively defined with a limiting end face for limiting an angular range of rotation of the connecting rod member relative to the finger base.
